(19) United States
(12) Patent Application Publication
(10) Pub. No.: US 2011/0106835 A1
(43) Pub. Date: May 5, 2011

(54) User-Defined Profile Tags, Rules, and Recommendations for Portal

(75) Inventors: Christina K. Lauridsen, Austin, TX (US); Malcolm C. Ong, New York, NY (US); Lauren G. Wilcox, New York, NY (US)

(73) Assignee: International Business Machines Corporation, Armonk, NY (US)

(21) Appl. No.: 12/608,423

(22) Filed: Oct. 29, 2009

(51) Int. Cl. G06F 17/30

(52) U.S. Cl. 707/769; 707/E17.108

(57) ABSTRACT

A mechanism is provided for providing control over personalization of portal content. The mechanisms provide new tag types and management of these tags to be used in association with a portal application. Applications of the new tag types comprise filtering of new content in the form of recommendations or search results and filtering of accessed content in the form of session summaries. Users may specify user context or state via one or more profile tags or enhanced profile attributes. Users may generate new rules for displayed portlets or portlet recommendation lists. User defined rules may be based on existing available rule-building capabilities and user-defined context tags or enhanced profile attributes and private or public portlet or portal page tags. The portal summary service may configure generation of portal session summary data according to user-defined context, portlet or portal tags, and rules.

### BACKGROUND

The present application relates generally to an improved data processing apparatus and method and more specifically to an apparatus and method for user-defined profile tags, rules, and recommendations for a portal application in a Web application server.

A Web portal presents information from diverse sources in a unified way. Apart from the standard search engine feature, Web portals may offer other services, such as e-mail, news, stock prices, information gathering, and entertainment. Portals provide a way for enterprises to provide a consistent look and feel with access control and procedures for multiple applications, which otherwise would have been different entities altogether.

Portlets are pluggable user interface software components that are managed and displayed in a web portal. Portlets produce fragments of markup code that are aggregated into a portal page. Typically, following the desktop metaphor, a portal page is displayed as a collection of non-overlapping portlet windows, where each portlet window displays a portlet. Hence, a portlet (or collection of portlets) resembles a web-based application that is hosted in a portal. Some examples of portlet applications are email, weather reports, discussion forums, and news.

An archive file is a file that is composed of one or more files along with metadata that can include source volume and medium information, file directory structure, error detection and recovery information, and file comments. An archive file usually employs some form of lossless compression. Archive files may also be encrypted in part or as a whole. Archive files may also be used to collect multiple data files together into a single file for easier portability and storage.

An Enterprise ARchive, or EAR, is a file format used by Java™ platform, Enterprise Edition for packaging one or more modules into a single archive so that the deployment of the various modules onto an application server happens simultaneously and coherently (Java is a trademark of Sun Microsystems, Inc. in the United States, other countries, or both). An EAR also contains extensible markup language (XML) files, called deployment descriptors, which describe how to deploy the modules.

Social bookmarking is a method for Internet users to store, organize, search, and manage bookmarks of Web pages on the Internet with the help of metadata, typically in the form of tags. In a social bookmarking system, users save links to Web pages that they want to remember and/or share. These bookmarks are usually public, and can be saved privately, shared only with specified people or groups, shared only inside certain networks, or another combination of public and private domains. The allowed people can usually view these bookmarks chronologically, by category or tags, or via a search engine.

A tag is a non-hierarchical keyword or term assigned to a piece of information, such as an internet bookmark, digital image, or computer file. This kind of metadata helps describe an item and allows it to be found again by browsing or searching. Tags may be chosen informally and personally by the item's creator and/or by its viewer, depending on the system.

Many social bookmark services encourage users to organize their bookmarks with informal tags instead of the traditional browser-based system of folders, although some services feature categories/folders or a combination of folders and tags. They also enable viewing bookmarks associated with a chosen tag, and include information about the number of users who have bookmarked them. Some social bookmarking services also draw inferences from the relationship of tags to create clusters of tags or bookmarks. Many social bookmarking services provide Web feeds for their lists of bookmarks, including lists organized by tags. This allows subscribers to become aware of new bookmarks as they are saved, shared, and tagged by other users.

### SUMMARY

In one illustrative embodiment, a method, in a data processing system, is provided for generating portal content based on user-defined tags and rules. The method comprises receiving, from a requesting user, a user-defined profile tag and a user-defined rule, identifying one or more portlets, from a set of stored portlets, to be presented to the requesting user, applying the user-defined rule to the one or more portlets based on the user-defined profile tag to filter the one or more portlets to form a filtered set of portlets, and returning the filtered set of portlets to the user.

In other illustrative embodiments, a computer program product comprising a computer usable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system is provided. The system may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2, a block diagram of an example data processing system is shown in which aspects of the illustrative embodiments may be implemented;

FIG. 3 is a diagram depicting a system for applying user-generated events to a grouping of bookmarked deployable Web archive files in accordance with an illustrative embodiment;

FIG. 4 depicts an example screen of display for performing a search in accordance with an illustrative embodiment;

FIG. 5 depicts an example screen of display of a Web portal window in accordance with an illustrative embodiment;

FIG. 6 is a block diagram depicting examples of components of a portal summary service in accordance with an illustrative embodiment;

FIG. 7 is a block diagram depicting examples of portlet instances specified according to recorded portal usage within summary portal pages in accordance with an illustrative embodiment;

FIG. 8 is a block diagram depicting one example of a portal summary page for portal usage at different times over a particular time period in accordance with an illustrative embodiment;

FIG. 9 is a block diagram depicting one example of a portal summary selection interface through which a user may select the portal usage to apply when specifying portlet instances within a summary portal page in accordance with an illustrative embodiment;

FIG. 10 is a flowchart illustrating operation of a system for applying user generated deployment events to a grouping of bookmarked deployable Web archive files in accordance with an illustrative embodiment;

FIG. 11 is a flowchart illustrating operation of a system for generating a portlet group for subsequent search, retrieval, and deployment as a portal tab in accordance with an illustrative embodiment;

FIG. 12 is a flowchart illustrating operation of a portal summary service recording portal usage in accordance with an illustrative embodiment;

FIG. 13 is a flowchart illustrating operation of a portal summary service generating a summary portal page in accordance with an illustrative embodiment; and

FIG. 14 is a flowchart illustrating operation of a portal summary service specifying a summary portal page in accordance with an illustrative embodiment.

### DETAILED DESCRIPTION

The illustrative embodiments provide a mechanism for providing a user a higher degree of control over personalization of portal content. Users may specify their own profile attributes and rules. The Web portal application may base recommendations for a user based on user-defined context and portal or portlet tags. Furthermore, a portal summary service may allow greater specification of what data is included in a session summary.

The mechanisms of the illustrative embodiments provide new tag types and management of these tags to be used in association with a portal application. Applications of the new tag types comprise filtering of new content in the form of recommendations or search results and filtering of accessed content in the form of session summaries, for example.

The mechanisms provide enhancements to Web portal application software and related database software. Users may specify user context or state via one or more profile tags or enhanced profile attributes. Users may store portlet page tags locally, or associate private tags with the user profile. Users may generate new rules for displayed portlets or portlet recommendation lists. User defined rules may be based on existing available rule-building capabilities and user-defined context tags or enhanced profile attributes and private or public portlet or portal page tags. A portal summary service may apply user-defined rules to both “live” and saved/cached portlet/portal content. The portal summary service may configure generation of portal session summary data according to user-defined context, portlet or portal tags, and rules.

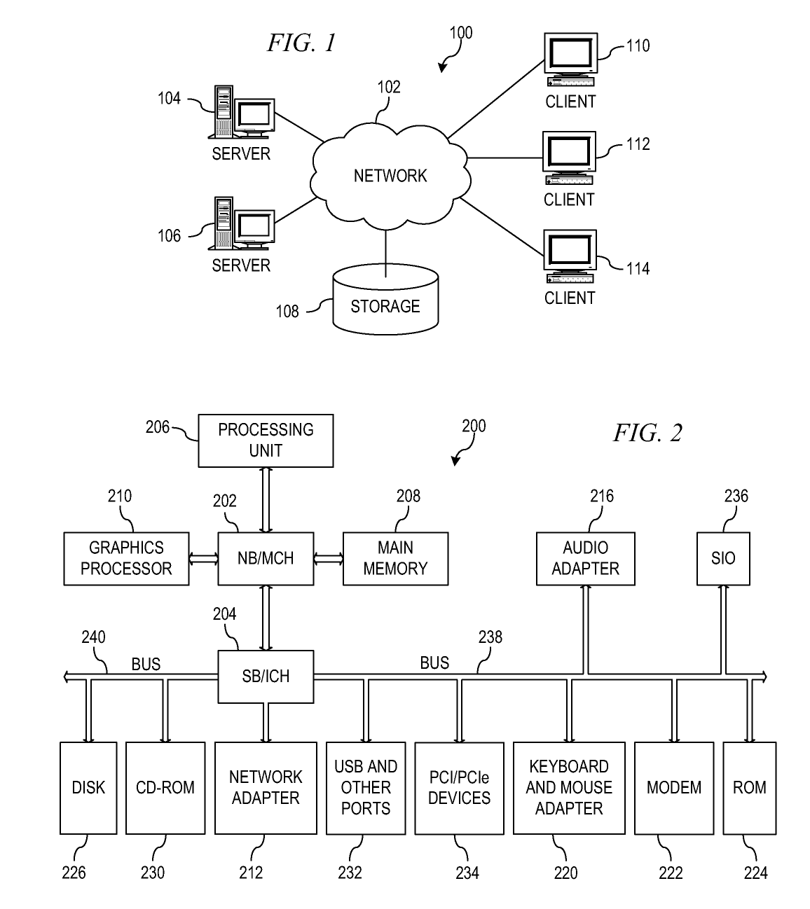

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation, this is only an example and is not intended to state or imply any limitation with regard to the features of the present invention. To the contrary, the illustrative embodiments are intended to include distributed data processing environments and embodiments in which Web archive files (portlets), and groups of portlets, are bookmarked, tagged, and deployed.

With reference now to the figures and in particular with reference to FIGS. 1 and 2, example diagrams of data processing environments are provided in which illustrative embodiments of the present invention may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In accordance with an illustrative embodiment, server 104, for example, may be a Web application server running a Web portal application, a portal summary service, and a bookmarking service. The portal summary service may store detected usage of instances of portlet applications within at least one portal page at different times. Responsive to a trigger to generate a summary portal page, the portal summary service dynamically creates a summary portal page displaying a separate instance of the portlet applications for specified times. The summary portal page provides a summary of selected usage of the portlet applications.

The bookmarking service may allow users at clients 110, 112, 114 to bookmark deployable Web archive files, i.e. deployable portlets. The bookmarking service may also allow users at clients 110, 112, 114 to group bookmarked Web archive files according to criteria, such as tag names, and to perform actions, such as a “deploy” action, to all members of the group in a single user-generated event.

For example, a user may choose to deploy all portlets (or up to a specified number of the most relevant) with a particular portlet tag, or portlets that meet some other criteria, such as deployed or tagged within a given time period by members of a particular group, with a single “deploy” event. The deploy event launches the specified portlet group within a new portal “tab,” within the user's portal.

The illustrative embodiments allow the user of the bookmarking service to bookmark and tag pre-configured portlet groupings, or portal tabs. Bookmarking portal tabs or other selected sets of portlet groupings allows users to share their personal configurations and layouts of portlets. Users may choose to deploy not just a tagged portlet, but an entire tab of portlets. As an extension of tagged portlet groupings, an example embodiment may also allow users to tag, bookmark, and deploy collections of portal tabs.

Furthermore, the illustrative embodiments allow the users of the bookmarking service to tag a larger grouping, and optionally allow a multitude of portlets in that grouping (e.g., deployed in a tab) to inherit the tag(s) of the larger grouping. Conversely, the illustrative embodiments may allow the users of the bookmarking service to allow the portlet grouping, or portal tab, to inherit the tag(s) of the individual portlets in the group.

Still further, the illustrative embodiments allow the users of the Web portal application to specify their own profile attributes and rules. The Web portal application may base recommendations for a user based on user-defined context and portal or portlet tags. Furthermore, a portal summary service may allow greater specification of what data is included in a session summary.

The illustrative embodiments may provide new tag types and management of these tags to be used in association with a portal application. Applications of the new tag types comprise filtering of new content in the form of recommendations or search results and filtering of accessed content in the form of session summaries, for example.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

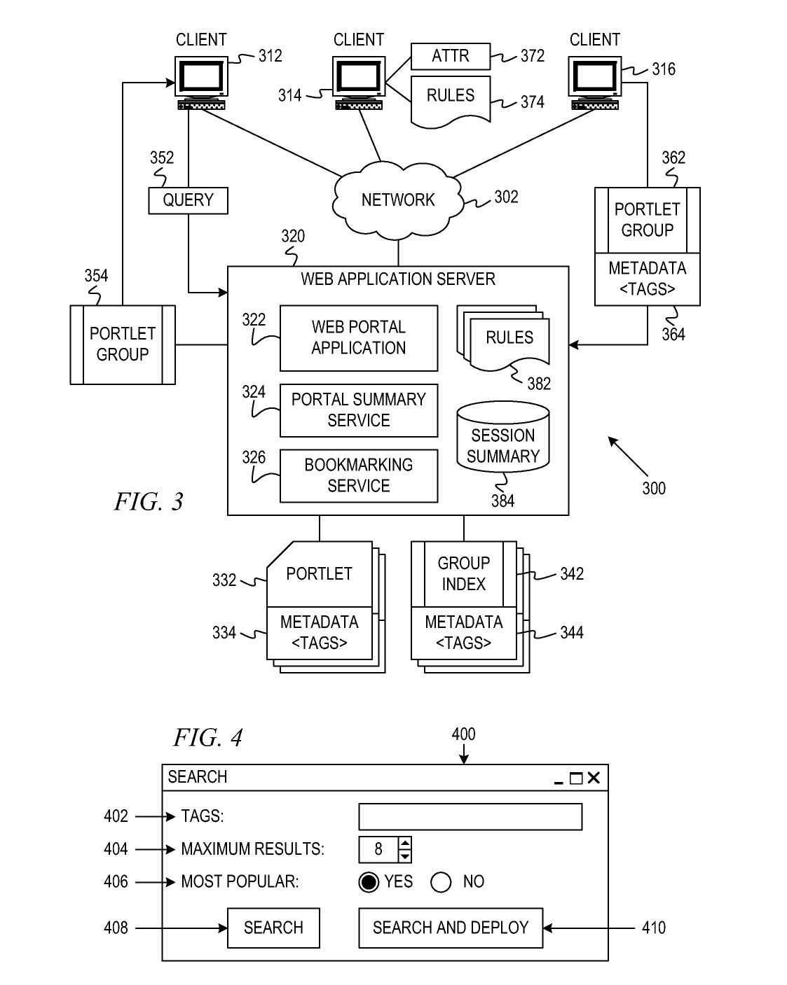

FIG. 3 is a diagram depicting a system for applying user-generated events to a grouping of bookmarked deployable Web archive files in accordance with an illustrative embodiment. In system 300, clients 312, 314, 316 connect to Web application server 320 via network 302. Web application server 320 comprises Web portal application 322, portal summary service 324, and bookmarking service 326. In accordance with the illustrative embodiment, bookmarking service 326 allows users at clients 312, 314, 316 to bookmark deployable Web archive files, i.e. deployable portlets viewable via Web portal application 322. Bookmarking service 326 may also allow users at clients 312, 314, 316 to group bookmarked Web archive files according to criteria, such as tag names, and to perform actions, such as a “deploy” action, to all members of the group in a single user-generated event.

A user at client 312, for example, may submit query 352 to Web application server 320 to request all portlets (or up to a specified number of the most relevant) with a particular portlet tag, or portlets that meet some other criteria, such as deployed or tagged within a given time period by members of a particular group. Web application server 320 and Web portal application 322 store portlets 332 with associated metadata 334. The metadata 334 may include, for example, for each individual portlet, developer assigned tags, user assigned tags, identification of users who have deployed the portlet, timestamp for the time/date that the portlet was deployed or tagged, popularity or number of tags/deployments, etc. Metadata 334 may be formed based on interaction with Web portal application 322 and bookmarking service 326 by users of clients 312, 314, 316.

Web application server 320 and Web portal application 322 receive query 352 and identify portlets among portlets 332 that satisfy query 352 based on metadata 334. Web application server 320 may then generate portlet group 354 based on the results of processing query 352, and return portlet group 354 to client 312. A user at client 312 may then view portlet group 354 and select all or a subset of the portlets within portlet group 354 to deploy in a portal tab within the user's portal. That is, the user may deploy all or a subset of the portlets within portlet group 354 using a single deploy event. The deploy event launches the specified portlet group within a new portal “tab,” within the user's portal via Web portal application 322.

The user at client 312 may individually select portlets within portlet group 354 from a list presented on a social bookmarking Web site via bookmarking service 326. For example, the user may perform a control+click action or may right-click on a portlet to activate an option for deploying in a tab. The user may also perform an advanced “search and deploy” query in which the user defines tag/attribute search criteria and chooses to automatically deploy a specified number of results matching the query as a group or portal tab. Once deployed, the portlet group 354, or portal tab, may be used as any other user-defined portal tab within Web portal application 322. The end user may edit a tab once she has chosen the tab for deployment.

Bookmarking service 326 may then add metadata 334 to portlets 332 as a result of deployment as a group. For example, for a given portlet 332, bookmarking service 326 may add to metadata 334 a separate user-defined tag, or set of tags, identifying the portal tab or grouping 354 with which the portlet has been deployed. Bookmarking service 326 may then retrieve this metadata 334 for subsequent viewing or searching.

Web portal application 322 may offer personalization options, such as simple filtering, rules engines, and collaborative filtering. Using simple filtering, a site displays content based on predefined groups of site visitors, which are defined by an administrator or site owner. Rules engines allow the site owner to define a set of business rules that determine the categories of content that are shown when a certain profile type visits the site. With collaborative filtering, a site visitor rates a selection of products, explicitly or implicitly. Those ratings are compared with the ratings offered by other visitors, and a software algorithm detects similarities.

Basic rule types offered by Web portal application 322 include profiler, action, binding, and visibility rules. Profiler rules classify users according to user attributes, which are defined by an administrator or site owner. Action rules select or upgrade content. For example, an action rule may select all of the company news articles intended for a current user's location or may update the user profile's list of articles read in order to avoid showing the same article more than once. Binding rules combine classifiers and actions to perform conditional logic. For example, a binding rule may specify that users with confidential clearance be shown the confidential company news and the non-confidential news, while users without confidential clearance are shown only the non-confidential news. Visibility rules define the conditions to show or hide portlets or pages based on specific circumstances such as user attributes or current date and time. The concept of creating visibility rules is the same as creating any other personalization rules.

Furthermore, Web portal application 322 offers a recommendation engine (not shown) that analyzes user interactions that occur and generates real time predictions and recommendations to users of clients 312, 314, 316. The recommendation engine may be at least one of a preference engine, a clickstream engine, or an item affinity engine. A preference engine generates recommendations using collaborative filtering algorithms based on the user's item ratings. A clickstream engine accesses transaction information and generates recommendations based on the history of user “clicks” during Web site visits. An item affinity engine generates recommendations based on the history of the user's site browsing activity and matches a currently selected product with a second product that the user is most likely to want to purchase along with the first product.

In accordance with an illustrative embodiment, users may specify their own profile attributes and rules. For instance, a user at client 314 specifies profile attributes 372 and user-defined rules 374. Attributes 372 may comprise new tag types and management of these tags to be used in association with Web portal application 322. More particularly, attributes 372 may specify a user context or state. For example, a given user at client 314 may use a portal while working or while on a vacation. In this example, the user may define attributes “work” and “travel.” The user may add these user-defined attributes and turn them on or off depending upon the user's current state or context.

At times the user may be in the “work” context or state, while at other times the user may be in the “travel” context or state. While in the “work” context or state, the user may view particular portlets, such as a spreadsheet portlet or a financial information portlet. On the other hand, while the same user is in a “travel” context or state, the user may view a weather portlet or a currency conversion portlet. Thus, the user may open a portal with a particular set of portlets and set the appropriate state or context.

The user may also tag the portlets with the user-defined profile tags. These tags may be stored in association with the portlet as a profile tag or attribute. These tags specify a descriptive tag for a portlet, but also specify information about the user. For instance, one user may assign a mapping portlet with a “travel” tag, because that user only views the mapping portlet while in a “travel” context or state. However, another user, who is a real estate appraiser, may assign the mapping portlet with a “work” tag. These associations between portlet tag and state or context may themselves be enhanced profile attributes for each given user. These tags also become enhanced “user state” tags for portlets or portlet groups or portal tabs.

As shown in FIG. 3, attributes 372 may be stored locally in association with client 314. Alternatively, attributes 372 may be stored in association with a user profile at Web portal application 322.

User-defined rules 374 may be based on existing available rule-building capabilities, user-defined context tags or enhanced profile attributes, and private or public portlet or portal page tags. For example, user-defined rules 374 may comprise profiler, action, binding, or visibility rules. A user at client 314 may be presented with a rule configuration Web interface that exposes capabilities. In one embodiment, profiler rules classify users according to user attributes 372, and may have the rule author's user identification as a required attribute. In another embodiment, visibility rules are enhanced to allow user attributes to include profile tags and enhanced profile attributes from attributes 372 as described above. Visibility rules may be enhanced to allow for portlet and portal page display based on one or more public portlet and portal page tags.

An alternative implementation may allow for rules or rule attributes to be stored in a user profile, and existence of a rule for a particular user may be indicated in a central repository (not shown) such that Web portal application 322 searches the user profile for rules and rule attributes when assembling a Web portal page.

Web portal application 322 may store rules 382, which may comprise site owner rules and user-defined rules. Thus, users may define rules locally, such as user-defined rules 374, and upload those rules to Web portal application 322.

In accordance with an illustrative embodiment, portal summary service 324 may store detected usage of instances of portlet applications within at least one portal page at different times. Portal summary service 324 stores the detected usage of instances of portlet applications as session summary data 384. Responsive to a trigger to generate a summary portal page, portal summary service 324 dynamically creates a summary portal page displaying a separate instance of the portlet applications for specified times. The summary portal page provides a summary of selected usage of the portlet applications based on session summary data 384.

In accordance with an example embodiment, portal summary service 324 may record portlet instance information with associated metadata, which may include user state or context or other enhanced user profile attributes 372, in session summary data 384. Recording in this context refers to saving a history of user interaction with a portal or portlet for a particular time interval. Thus, rules 374 may define portal content to display for saved or cached portal content. That is, portal summary service 324 may generate a session summary portal page from session summary data 384 by filtering the session summary data 384 based on user-defined rules and profile attributes.

For example, a user may wish to generate a summary report on “Project X” for use in a meeting on that project the following day. The user has tagged three portlets with “Project X” and created a rule that specifies to record interaction with “Project X” tagged portlets when her enhanced user attribute is set to “Project X.” The user selects her enhanced user attribute to “Project X.” While interacting with the portal in this state or context, the user interacts with the three “Project X” tagged portlets, but also periodically interacts with a “Stock Quote” tagged portlet that is not associated with the tag “Project X.” In this example, portal summary service 324 may generate a summary portal page at the end of the session displaying instances of the three “Project X” portlets, but not the “Stock Quote” portlet.

In accordance with one illustrative embodiment, Web portal application 322 may comprise a recommendation engine (not shown) that bases recommendations on collective user ratings and clicks, the particular user's browsing activity, and user-specified context and private or public tags. For example, a user may have a set of portlets that the user views for “work” and another set that she uses for “school.” The user may be interested in both and use both, but at different times. The user may define enhanced profile attributes for state or context that include “work” and “school.” The user may also tag some of the portlets with “work” and tag other portlets with “school.” The user may belong to collaborative communities for both groups that tag and recommend portal content. If the user is in a “work” context, as set by the user in the enhanced profile attributes, then the user would not want Web portal application 322 to recommend content related to “school,” regardless of how important or relevant the content may be. Perhaps the user would be interested in this content later, but not while in the “work” context or state. Also, the user may specify to Web portal application 322 that while in the “work” state, recommendations for portal content will be based only on browsing activity related to “work” tagged portlets or on community recommendations from the “work” related group.

As another example, a user may use four portlets in her current portal session. In this scenario, the user is planning a trip, and in the middle of planning she checks her current investments. She has activated profile tags “work” and “management.” She has used Portlet A with portlet tags “travel” and “conference” first. She then moves to Portlet C with portlet tags “travel” and “flights.” Then, she uses Portlet B with portlet tags “finance,” “401(k),” and “portfolio,” and finally uses Portlet D with portlet tags “travel” and “hotels.” The user now wishes to generate a summary. The user may see usage states associated with all of the profile tags she had active during the session (“work” and “management”) as well as unique individual portlet tags (“travel,” “flights,” “finance,” “401(k),” “portfolio,” and “hotels”).

However, in this example, the user wishes to generate a summary of her travel planning activity in the portal session. The user filters on tags (“travel,” “flights,” and “hotel”) and sees portlet application state histories of her usage in order of Portlet A, Portlet C, and Portlet D (Portlet B is left out). If she now wishes to see the portlet usage history for the portlets that she spent the most time using, then she can filter by duration of use, etc.

A user at client 316, for example, may generate a portlet group 362 or portal tab, either by individually selecting portlets using Web portal application 322 or by submitting a query or “search and deploy” query, as described above. The user may assign, via the user interface provided within the portal tab by Web portal application 322, a tag or set of tags for the portlet group 362. Client 316 may then submit these tags, and other attributes, to Web application server 362 as metadata 364 in association with portlet group 362. For instance, the user at client 316 may select a “save” feature for the portal tab within the user's portal.

The user may manually enter one or more tags for portlet group 362 or may be presented with an option to select from tags that are already applied to the individual portlets within the portlet group 362. Portlets residing in a tagged tab, or other tagged grouping of portlets, may inherit the tag(s) of the tab or larger grouping so that they may be individually found and deployed based on the inherited tags, as well as the tags they already possessed. The end user tagging a tab or grouping may also choose to allow the portlets deployed within the portal tab to inherit the same tag(s).

Bookmarking service 326 may automatically flag a portlet that is added for deployment to a tagged tab or other tagged grouping as a potential inheritor of the tag(s) already applied to the tab or larger grouping. The end user may be given the option, during deployment of a portlet within a portal tab, to allow the new portlet to inherit the tag(s) of the portal tab. Bookmarking service 326 may automatically flag a portlet that is added for deployment to a tab that contains other tagged portlets as a potential inheritor of the tag(s) of the other portlets in that portlet group. The end user may be given the option to apply the tags of the other portlets in the same group, collectively or individually, upon choosing to assign a tag to the newly deployed portlet.

Responsive to Web application server 320 receiving portlet group 362 and associated metadata 364, bookmarking service 326 may generate an instance of the portlet group by creating a group index 342 with reference to data structures containing: portal grouping identifier, tags, references to portlets contained within the grouping, information about deployment, such as who deployed or tagged the grouping, when the portlet group was tagged or deployed, how frequently the portlet group was tagged or deployed, and so forth. Bookmarking service 326 then stores this information as metadata 344 in association with the group index 342. Web application server 320 then stores a plurality of deployed portlet groups, such as portlet group 362, by creating group indexes 342 and associated metadata 344, each group index 342 and associated metadata 344 representing an instance of a portlet group or portal tab.

An augmented search capability of bookmarking service 326 may allow users of clients 312, 314, 316 to search not only individual tabbed portlets, but also tagged portlet groupings. Web portal application 322 may then deploy groups of portlets through a selection list or via an advanced “search and deploy” query or action. If a user selects multiple portlet groups from a list, then Web portal application 322 may deploy each portlet group as a tab in a Web portal.

Upon deploying a portlet group, a user may select a new name for the tab and edit tags corresponding to the tab to fit the portal environment of the user. A user who deploys a tab or portlet group that has been bookmarked by another user may deploy the tab such that the metadata containing configuration options and information about layout, skins, and placement of the portlets is by default those of the other user. The user may then choose to edit these configuration options and settings upon deployment within her own portal.

As an example implementation, a recently promoted director may be preparing for a meeting with her executive manager in which all financial information for her sales organization will be reviewed. One of her direct reports, a manager in the team “Software Sales” has deployed several finance portlets and has grouped them into a tab entitled “Software Sales Finances.” The financial information includes results from sales in multiple regions and for multiple product lines. The manager has six different portlets deployed corresponding to quota management, sales by regions, employee performance, and summaries of costs, expenses, and revenue, all grouped under the “Software Sales Finances” tab that she created. The newly promoted director knows that one of the managers on her team has this collection of finance portlets deployed in a portal tab. She also knows that portlet bookmarking capability allows her to search for the manager's bookmarked portlets. The director may find each portlet if that portlet is bookmarked, and deploy each one in her own tab. The new director uses the social bookmarking service in her portal to view the bookmarks of the manager, sorts by tag name, and finally sees all of the finance portlets. One by one, she chooses to deploy them. Choosing portlets individually, this would take many clicks and the director would have to regroup them in a tab of her own, setting the configuration again.

However, using the aspects of the illustrative embodiments, the director may simply visit the social bookmarking service within her portal. She navigates to her employee group and finds the manager who has grouped the portlets she needs. The director may browse not only the bookmarked portlets, but also the bookmarked tabs (and groups of tabs) of her employees. She sees that the manager has bookmarked the “Software Sales Finances” tab, which contains the configuration options for the portal tab and portlets. She can now deploy the entire tab, portlets included, with a single deploy event. She also has the option of changing the name of the tab at this time. The new portal tab, and all portlets deployed in the tab, are created. With a simple search and a single deploy event, the director is presented with the information she needs to be prepared for her meeting.

Furthermore, the director may filter portlets within the portal tab by user context or state. That is, the manager may deploy only those portlets that the employee group interacted with while working on a particular project, for example. To accomplish this, the director simply defines a rule to filter portlets based on enhanced profile attributes. Alternatively, the Web portal application may automatically filter portlets based on the director's current state or context and user-defined rules. For instance, the director may have a standing rule to filter portlets based on her current state or context.

FIG. 4 depicts an example screen of display for performing a search in accordance with an illustrative embodiment. Search dialog 400 presents controls for performing search of portlets to form a portlet group or portal tab, including a tags text entry control 402, a maximum results selection control 404, and a most popular radio button control 406, for example. In the depicted example, the user may enter one or more tags for searching portlets in tags text entry control 402. For instance, the user may enter a single tag or a string of tags delineated by commas in control 402.

Using maximum results selection control 404, the user may select a number of portlets matching the search query to return in the resulting portlet group. The most popular radio button control 406 allows the user to instruct the Web application server to return only the most popular portlets, e.g., the eight most popular portlets in this instance. Search dialog 400 may include more or fewer controls for defining a search query depending upon the implementation. For example, search dialog 400 may include controls for selecting particular users who have tagged or deployed portlets, how recently portlets have been tagged or deployed, and so forth.

Search dialog 400 includes “search” button 408. If the user selects “search” button 408, the Web application server will return a list of portlets matching the query for selection by the user. Search dialog 400 also includes “search and deploy” button 410. If the user selects “search and deploy” button 410, the Web application server and Web portal application will deploy the resulting group of portlets as a portal tab.

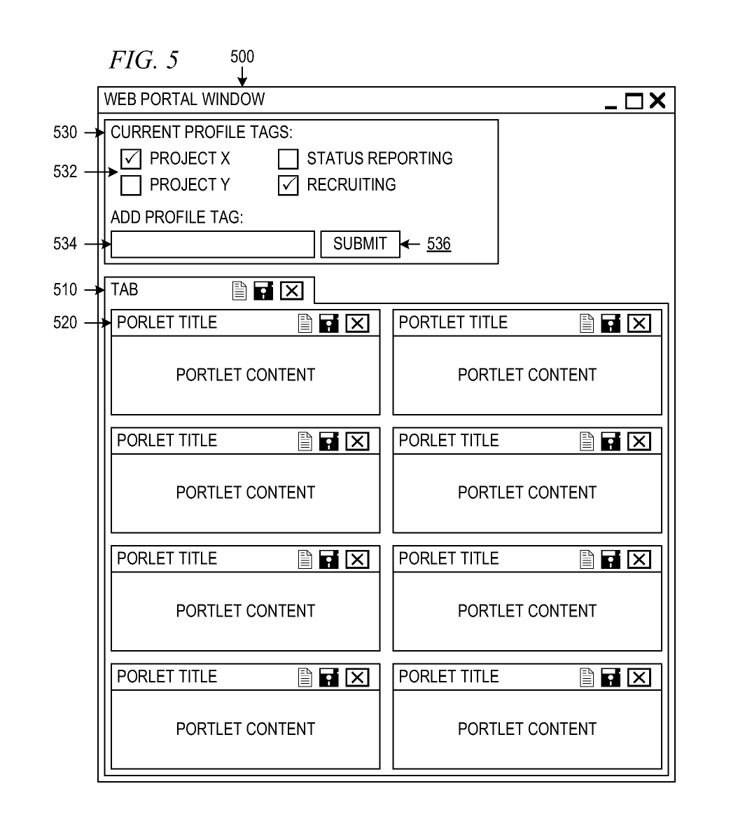

FIG. 5 depicts an example screen of display of a Web portal window in accordance with an illustrative embodiment. Web portal window 500 includes a tab 510 comprising a plurality of portlets 520. Web portal window 500 also includes profile tags dialog portion 530. Profile tags dialog portion 530 displays a plurality of profile attributes or tags 532, which the user may turn on or off using checkboxes. The user may also add user-defined profile attributes using text entry field 534 and submit button control 536. When the user enters a new profile attribute, which may be a context or state tag or other enhanced profile attribute, into text field 534 and selects submit button control 536, the new profile attribute is added to profile attributes 532.

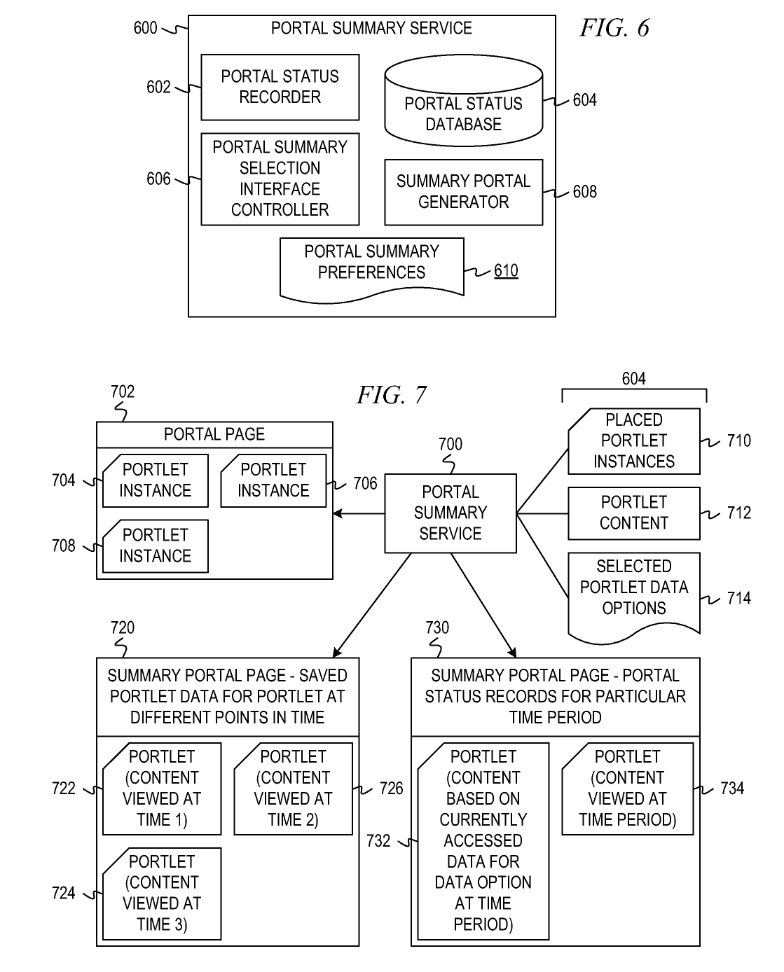

FIG. 6 is a block diagram depicting examples of components of a portal summary service in accordance with an illustrative embodiment. It will be understood that in additional or alternate embodiments, the portal summary controller may include additional or alternate components.

In the example, portal summary service 600, which may be portal summary service 324 in FIG. 3, for example, includes portal status recorder 602. Portal status recorder 602 monitors the usage of one or more portal pages and records and stores portal usage with a time stamp and other available information in a portal status database 604. As previously noted, portal usage may include, but is not limited to, which portlet instances are open within a portal page, the selected data options for open database driven portlets, and the dynamically generated content of portlet instances within a portal page. It is important to note that dynamically generated content may include, but is not limited to, text, graphics, audio, video and streaming multimedia content.

In one example, as portal status recorder 602 records and stores portal usage records within portal status database 604, to indicate when portal usage is recorded, portal status recorder 602 may adjust a graphical characteristic or other output characteristic of individual portlet instances within a portal page or may adjust a graphical characteristic or other output characteristic within the portal page itself. For example, each time portal status recorder 602 records the portal usage for a portal page, portal status recorder 602 may add a time stamp to a portion of the portal page indicating when the portal usage was recorded and stored for the portal page. In another example, each time portal status recorder 602 records the portal usage for a portal page, portal status recorder 602 may temporarily adjust a graphical attribute or characteristic of the portal page or an individual portlet instance within the portal page, such as by adding shading or adjusting a coloring of a portal page or individual portlet instance within the portal page. In yet another example, where portal status recorder 602 monitors portal usage within multiple portal pages, portal status recorder 602 may simultaneously update a graphical characteristic of each of the monitored portal pages or graphically distinguish a selection of recorded portal pages from at least one portal page for which usage is not recorded.

In monitoring usage of one or more portal pages, portal status recorder 602 determines when to record and store portal usage within portal status database 604. In one example, portal status recorder 602 records each change in portal usage detected, such as recording each change in the portlets selected for view within a portal page, each change in the data option selected for a portlet instance, and each change in the dynamically generated content of a portlet instance within a portal page. In another example, portal status recorder 602 may support an application program interface to include a selectable option within one or more portlet instances or within a portal page that allows a user to select an option to direct portal status recorder 602 to record and store the current usage of a particular portlet instance or portal page as a whole. In yet another example, portal status recorder 602 may determine when to record and store portal usage in portal status database 604 based on recording settings in portal summary preferences 610. For example, portal summary preferences 610 may specify recording settings for recording and storing the portal usage periodically, according to calendared events set for the portal or in a separate calendaring application, according to the type of portlet, and according to other criteria or rules.

Portal summary service 600 also includes portal summary selection interface controller 606. In one example, portal summary selection interface controller 606 provides an interface with a list or other selectable representation of one or more records representing portal usage recorded in portal status database 604. A user, selecting from the list, may customize or configure those records of portal usage for summary portal generator 608 to include in a summary portal page. In another example, portal summary selection interface controller 606 may include selectable options within an interface for a user to select a particular portlet and select a time period over which to display all the portal usage for the particular portlet stored in portal status database 604 within a summary portal page generated by summary portal generator 608. Further, in another example, portal summary selection interface controller 606 may include selectable options within an interface for a user to select to automatically direct summary portal generator 608 to create a portal page for all or a selection of portal usage contemporaneously with the recording of the portal usage within portal status database 604.

In addition to a user directly selecting which selection of portal usage stored in portal status database 604 to include in a summary portal page, portal summary preferences 610 may specify preferences for specifying the selection of portal usage stored in portal status database 604 for summary portal generator 608 to include in a summary portal page. In one example, portal summary preferences 610 may indicate a preference to automatically generate a summary portal page for each record of portal usage recorded in portal status database 604. In another example, portal summary preferences 610 may indicate a preference to automatically generate a summary portal page on the morning of each business quarter including a separate portlet instance of a particular portlet application for each of the previously recorded business quarters with each portlet instance displaying the content stored for the portlet application at the end of the current quarter or one of the previous quarters.

In creating a summary portal page, summary portal generator 608 may create a portal page which may include at least one portlet instance of at least one portlet application which functions as if placed on a normal portal page with the data options for database driven portlets specified according to the data options for the portlets specified at a previous point in time as accessed from portal status database 604. Based on the previously specified data options, the portlet instance in a summary portal page displays dynamically generated content for the portlet based on the current data for the previously selected data option.

In addition, in creating a summary portal page, summary portal generator 608 may create a summary portal page in which portlet instances may function as if placed on a normal portal page, however the content of the portlet instance is specified with the content previously displayed within the portlet instance of a same portlet application at a previous point in time as accessed from portal status database 604. In this example, the summary portal page may include multiple portlet instances each specified with content accessed from portal status database 604 as recorded at a same point in time or different points in time.

Further, in creating a summary portal page, summary portal generator 608 may create a summary portal page which includes portlet instances for those portlet applications recorded as placed within a portal page over a particular time period within portal status database 604, with a default data option selected. In this example, in addition to allowing a user to specify the portlet instances open within a portal page, the user may store time based recordings of which portlet instances were open within a portal page at different points in time and access a summary portal page with the portlet instances open at one of the different points in time as recorded in portal status database 604.

Moreover, in creating a summary portal page, summary portal generator 608 may direct a Web portal application to create the summary portal page with a selection of one or more portlets and one or more of a selection of data options set for the portlets and a selection of stored content to display in the portlets. In addition or alternatively, summary portal generator 608 may create a portal page separately from the Web portal application with the selection of one or more portlet instances and one or more of a selection of data options set for the portlet instances and a selection of stored content from portal summary preferences 610 to display in the portlet instances.

In one example, summary portal generator 608 creates a summary portal page within a separate window. In another example, summary portal generator 608 creates the summary portal page within an interface which adds a new tab to support a new portal page and summary portal generator 608 places the summary portal page within the tab.

Further, in creating a summary portal page, summary portal generator 608 may graphically distinguish the portions of the content displayed within the summary portal page which are based on records from portal status database 604 from the portions of the content displayed within the summary portal page which are based on current data accesses. In addition, as a user interacts with the summary portal page, the user may change data option selections within one or more portal instances and summary portal generator 608 specifies user selected changes according to the same graphical characteristic used to distinguish current data accesses. For example, portions of the content displayed within the summary portal page based on records from portal status database 604 may be highlighted with a distinguishable color, texture, hue, or other graphical indicator which facilitates visual distinction of content based on records from portal status database 604 from the other content displayed within the summary portal page.

It is important to note that portal status database 604 may be stored at a client system or at a portal server system. In the example where portal usage is stored at a client system, portal status database 604 may represent a database within memory or may represent data stored with cache. In addition, separate storage systems for storing portal usage may be accessible to client systems or portal server systems via a network.

In one example, where portal usage is stored at a client system, portal status recorder 602 may store data points within portal status database 604 and a rich client portal application running at the client system renders portlets locally from the data points for output within a summary portal page managed by summary portal generator 608. In addition, in the example where portal usage is stored at a client system, portal status recorder 602 may store HTML fragments, as previously described, within portal status database 604 and a rich client portal application renders portlets locally from the HTML fragments by running a file server portlet that allows display of HTML content. In yet another example, where portal usage is stored at a client system, portal status recorder 602 may capture and store static snapshot images of a portlet instance and summary portal generator 608 generates HTML from the snapshot for rendering through a rich client portal application running a file server portlet that allows display of HTML content.

In the example, where portal usage is stored in portal status database 604 at a portal server system, portal status recorder 602 may record into portal status database 604 data points, HTML, or static snapshot images, as described with reference to locally storing portal usage. Portal summary preferences 610 or other preferences are set to point to portal status database 604 at the portal server system. The portal server system renders the content for display in the portlet instances in a summary portal page from the stored data points, HTML or static snapshot images.

In addition, it is important to note that while the invention is described with reference to summary portal generator 608 accessing portal status database 604 to generate summary portal pages, other controllers or functions may access portal status database 604. For example, when a user is offline or not able to access a data server system for a portlet, portlet applications may access previously accessed and stored content from portal status database 604, and dynamically generate content for display within portlet instances while offline or not able to access a data server system for a portlet.

FIG. 7 is a block diagram depicting examples of portlet instances specified according to recorded portal usage within summary portal pages in accordance with an illustrative embodiment. In the example, portal summary service 700 monitors portal usage of a portal page 702 which includes portlet instances 704, 706, and 708. Portlet instances 704, 706, and 708 may represent instances of a same portlet application or different portlet applications. In addition, at least one of portlet instances 704, 706, and 708 represents an instance of a database driven portlet.

In the example, portal summary service 700 detects and stores, at one or more points in time, within portal status database 604, the portal instances open within portal page 702 as illustrated at reference numeral 710, the portlet content within at least one portlet within portal page 702 as illustrated at reference numeral 712, and the selected portlet options within at least one portlet within portal page 702 as illustrated at reference numeral 714. In addition, although not depicted, portal summary service 700 may detect and store portal usage from other portal pages in portal status database 604.

In one example, portal summary service 700 generates a portal summary page of the saved portlet content for a same portlet application over multiple points in time. For example, portlet content 712 may store the portlet content for a financial portlet each month. Summary portal page 720 includes multiple instances of the financial portlet illustrated by portlet instances 722, 724, and 726. Each of the portlet instances includes the content saved for one of the previous months in the financial portlet instances displayed within portal page 702 or other portal pages. Thus, a user may select to view a summary of multiple instances of a same portlet application with the content displayed for that portlet at different points in time.

In another example, portal summary service 700 generates a portal summary page 730 of the portlets accessed at one or different times during a particular time period. In the example, portal summary page 730 includes instances of each of the portlets recorded as placed within portal page 720 at a particular point in time. For portlet instance 732, the portlet instance is set to access the content currently available for the data option selected at the particular time period. For portlet instances 734, the portlet instance is set to display the content stored for the portlet at the particular time period. Thus, a user may select to view a summary of instances of portlets placed in a portal page at a particular time and either access current content for the data option selected at the point in time or access the content that was displayed in the portlet at the point in time.

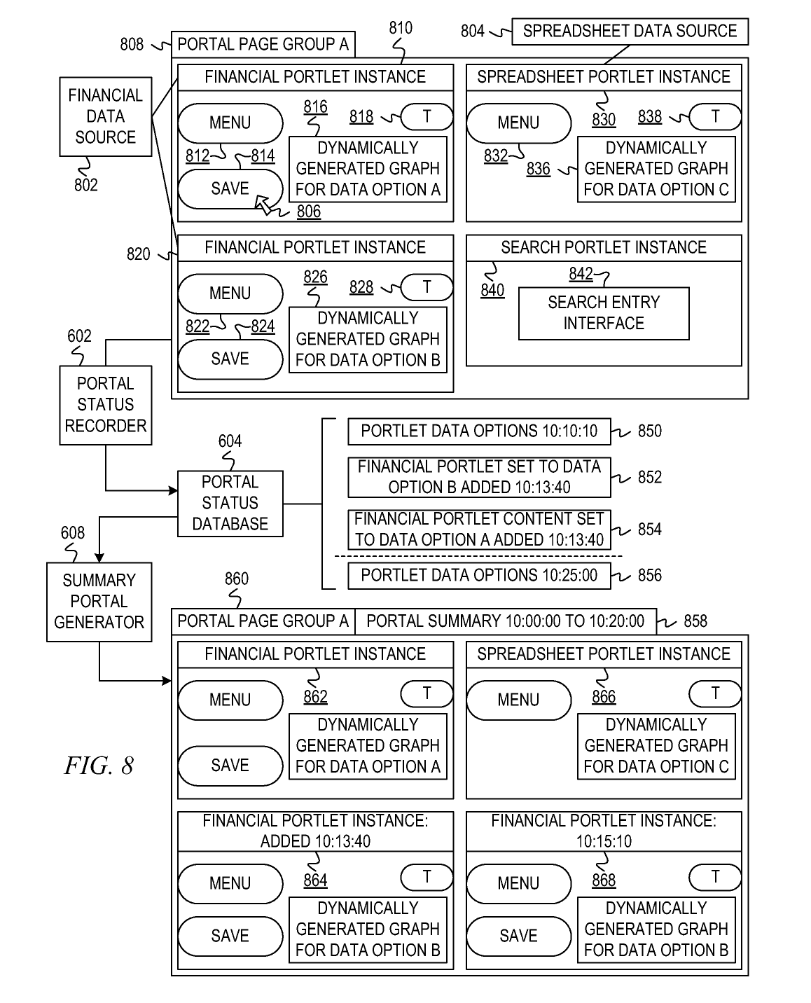

FIG. 8 is a block diagram depicting one example of a portal summary page for portal usage at different times over a particular time period in accordance with an illustrative embodiment. In the example, within a first portal page displayed within an interface that facilitates tabbed windows for rendering portal pages, a first “portal page group A” is illustrated as depicted at reference numeral 808. The portal page illustrated for the tab depicted at reference numeral 808 includes financial portlet instances 810 and 820 from financial data source 802, a spreadsheet portlet instance 830 and a search portlet 840 from spreadsheet data source 804. Each of financial portlet instances 810 and 820 and spreadsheet portlet instance 830 are instances of database driven portlets and include a menu of selectable data options, respectively illustrated at reference numerals 812, 822, and 832. In alternate embodiments, additional or alternate types of selection interfaces from the menu selections may be implemented. For example, data options may be selectable from multiple selectable words or links displayed within a portlet instance which may result in dynamically generated graphs 816, 826 and 836.

In the example, those portlet instances which are recordable according to user preferences are marked with a graphical indicator as illustrated by graphical indicators 818, 828, and 838. Portal summary preferences 610 in FIG. 6, for example, may specify that only those portlets which are database driven and therefore include dynamically generated content, are to be monitored and the usage of stored. In the example, portlet instances 810, 820, and 830 are instances of database driven portlets which dynamically generate content based on the current data specified for a selected data option. In contrast, a search portlet instance 840 with a search entry interface 842 into which a user may enter any term is not an instance of a database driven portlet and is not marked as being recorded. In other embodiments, usage of portlets that are not database driven, such as search portlet 840, may be recorded. In addition, in other embodiments, graphical indicators 818, 828, and 838 or separate graphical indicators may be updated within portlet instances to indicate the usage of the portlet instance has been saved.

In the example, portal status recorder 602 records the portal usage within the portal page as illustrated with reference to multiple records of portal status database 604. Portal status recorder 602 may determine from portal summary preferences 610, user inputs, and other specifications, which portal usage to record.

For example, portal status recorder 602 is directed to periodically record the currently selected portlet data options. In the example, the period is every fifteen minutes, as illustrated by record 850 recorded at 10:10:00 and record 856 recorded at 10:25:00. Although not depicted, in each of record 850 and record 856, the current data options selected within the placed, recordable portlets, are recorded.

In addition, for example, portal status recorder 602 is directed to record each time a portlet instance is added to a portal page or withdrawn from a portal page. In the example, when financial portlet instance 820 is added to the portal page, record 852 records the time the portlet instance was added and the data option of “option B” selected within the portlet instance.

Further, for example, portal status recorder 602 is directed to record the content within portlet instance 810 responsive to the user selection of save option 814 using cursor 806. As illustrated within portlet instances 810 and 820, save options 814 and 824 allow a user to select to save the contents of each of these portlet instances individually. In the example, when the user selects to save the content of portlet instance 810 within portal status database 604 or another database that the user selects, record 854 within the selected database includes an identifier for portlet instance 810, the time of saving the content, the content itself, and the data option selected within portlet instance 810.

Subsequent to portal status recorder 602 storing records of portal usage in portal status database 604, a user may request to view a summary of portal usage at different points during a range of time. In the example, the user selects to view a summary of portal usage during a time range from 10:00:00 to 10:20:00. Records 850, 852, and 854 are relevant to the search period range.

As illustrated, summary portal generator 608 generates a new summary portal page 858 within the display area. Using cursor 806, a user may select between portal page 808 and summary portal page 858 by selecting one of the tabs within a tab interface 860. In additional or alternate examples, summary portal generator 608 may open a separate window for displaying summary portal page 858. In addition, in additional or alternate examples, summary portal generator 608 may open summary portal page 858 within the browser or other interface at the client system where the client system interface specifies the interface for selecting between multiple portal pages.

In particular, summary portal generator 608 generates summary portal page 858 with a first selection of portlet instances representative of the portlets placed within portal page and the data options selected for those portlets, as recorded in record 850. For example, summary portal page 858 includes financial portlet instance 862, financial portlet instance 864, and spreadsheet portlet instance 866 which are set to “option A,” “option B,” and “option C,” respectively, reflective of the portlet placement and data option selections at 10:10:00 when portal status recorder 602 recorded the portal usage in record 850 and reflective of the portlet addition at 10:13:40 when portal status recorder 602 recorded the portal usage in record 852. Each of financial portlet instance 862, financial portlet instance 864, and spreadsheet portlet instance 866 include the current, dynamically generated content for the data option selections recorded in record 850 of “option A,” “option B,” and “option C,” respectively.

In addition, summary portal generator 608 generates summary portal page 858 with a second selection of portlet instances displaying the content recorded in record 854. For example, summary portal page 858 includes financial portlet instance 868 which includes the saved content for data option A, reflective of the portlet instance content at 10:15:10 when portal status recorder 602 recorded the portal usage in recorder 854.

In the examples of records 850, 852, 854, and 856, stored within portal status database 604 or one or more other databases selected by a user or portal summary controller, additional or alternate data that is available or analyzed may be stored with each of the records and displayed in the summary. For example, a record may include content of a portlet and a summary of the stored content.

In addition, in the example of summary portal page 858, in other examples, the user may select or summary portal generator 608 may automatically generate a summary portal page reflective of only particular types of portal usage records. For example, summary portal page may only reflect recorders with portlet placement and data options selected or may only reflect records with portlet content stored.

Further, it is important to note that in another example, the summary portal page may be generated at a particular point in time and then be set for summary portal generator 608 to automatically update summary portal page each time portal status recorder 602 records a new record in portal status database 604.

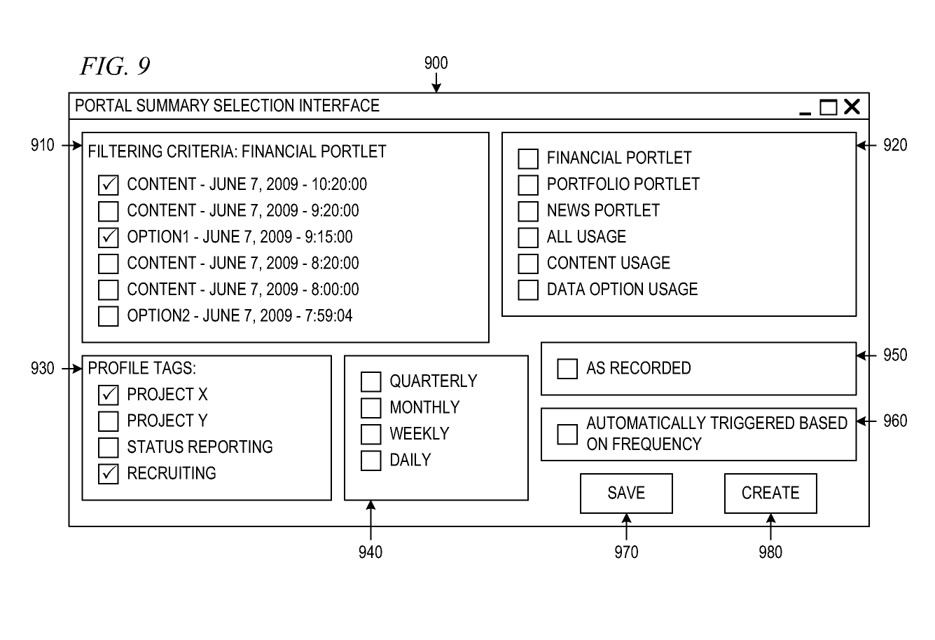

FIG. 9 is a block diagram depicting one example of a portal summary selection interface through which a user may select the portal usage to apply when specifying portlet instances within a summary portal page in accordance with an illustrative embodiment. In the example of a portal summary selection interface 900 facilitated by portal summary selection interface service 606 in FIG. 6, a user may select from a list of records of portal usage stored in portal status database 604, as illustrated in the list at reference numeral 910. In particular, as illustrated in the example, the user may first select to view a filtered selection of the records of portal usage stored in portal status database 604 by selecting a filtering criterion from a pull down menu or other input which enables selection from a pull down list. In the example, a user has selected to view all records within portal status database 604, which include instances of a financial portlet. As illustrated, the examples of selectable records within portal status database 604, which include instances of a financial portlet, include time based records of saved content for the financial portlet and saved option selections for the financial portlet. From among the filtered list illustrated at reference numeral 910 a user may further select which of the records to include within a summary portal page by individually selecting records.

While the example illustrates the list of portal usage from portal status database 604 filtered according to a type of portlet, in other examples, a user may select other filtering criteria such as a time range, whether the record is for content, whether the record is for an option, whether the record indicates the portlets opened at a particular time, and other criteria which distinguish a selection of records from among portal status database 604.

In addition, in the example of portal summary selection interface 900, in addition to or as an alternative to selecting from the list at reference numeral 910, portal summary selection interface service 606 may include options for specifying the types or categories of records to include within the portal summary page. In the example, as illustrated at reference numerals 920, 930, and 940, a user may select from options including types of portlet instances, such as “financial portlets,” “portfolio portlets,” and “news portlets,” frequency of portlet usage, such as “quarterly,” “monthly,” “weekly,” or “daily,” user-defined context or state tags, such as “Project X,” “Project Y,” “Status Reporting,” and “Recruiting,” and may select whether to record all portal usage, content usage or data option usage. It will be understood that the category examples depicted at reference numerals 920, 930, and 940 are for purpose of illustration of the types of options portal summary selection interface service 606 may present within portal summary selection interface 900 and are not limiting on the types or formats of criteria a user is enabled to select from to specify the recorded portal usage to include within a summary portal page.

In particular, a user may also select an “as recorded” option 950 to add portlet instances reflecting all or selected types of records within portal status database 604 as the records are recorded by portal status recorder 602 and stored in portal status database 604. In one example, a user may select to open a summary portal page which will provide a summary of each of the portlet content changes throughout a session, by selecting the “content usage” option and option 950 within portal summary selection interface 900. By updating the summary portal page as the content changes within one or more other portal pages, the user may switch to view the summary portal page and view a record of previously displayed dynamic content over a particular time period.

In the example, a user may select a save option 970 to select to save selected options for specifying the portlet instances within a summary portal page. In addition, upon choosing the save option depicted at reference numeral 970, portal summary selection interface controller 606 may prompt the user to name the selected options for the summary portal page and portal summary selection interface service 606 saves the selected options as a file or other data storage unit.

Through portal summary selection interface 900, a user may select options for multiple separate summary portal pages and may select to open separate summary portal pages by selecting to open one or more of the saved option files. For example, as illustrated, the user selects to save options for a summary portal page specified for the portal usage of the content of a financial portlet on “June 7, 2007” at “10:20:00” and of a financial portlet instance set to data “option 1” on “June 7, 2007” at “9:15:00.” The user may later select the saved option file to trigger summary portal generator 608 to create a summary portal page with portlet instances specified according to the saved records.

In addition, a user may select options for a summary portal page within portal summary selection interface 900 and select to create the summary portal page through selection of the create option depicted at reference numeral 980. When the user selects the create option illustrated at reference numeral 980, summary portal generator 608 detects the applicable records from portal status database 604 designated by the user selected options and generates a summary portal page including portlet instances specified according to the applicable records.

In addition, through portal summary selection interface 900, a user may select options for multiple separate summary portal pages, where the selected options trigger opening separate summary portal pages. For example, a user may select an option for a summary portal page with records for the news portlet as recorded daily. A user may further select an option 960 to automatically trigger a summary portal page, based on the selected frequency, such as triggering a summary portal page each day with portlet instances specified according to the records of the news portlet for the day.

It will be understood that portal summary selection interface 900 may include additional or alternate options. In addition, it will be understood that a system administrator or user may specify the types of options to be included within portal summary selection interface 900. Further, a user may select to view portal summary selection interface 900 or portal summary selection interface service 606 may automatically trigger display of portal summary selection interface 900 periodically or responsive to different conditions.

It is important to note that in addition to portal status recorder 602 monitoring portal usage of one or more portal pages, portal status recorder 602 may monitor portal usage of a summary portal page and records of portal usage of a summary portal page may be included within portal summary selection interface 900 for user selection to include in another summary portal page. In one example, a summary portal page may include portlet instances specified according to recorded data options from portal status database 604, but the user could specify a preference to record the content accessed for the previously selected data options within the summary portal page and present the summary of the content recordings in the same or an alternate summary portal page.

It is also important to note that in displaying records from portal status database 604, portal summary interface service 606 may detect which records within portal status database 604 include redundant information and graphically illustrate redundant records within portal summary selection interface 900. For example, if multiple records for a financial portlet include a same data option selection, each of the redundant records may be graphically highlighted to show the redundancy. In addition, portal summary selection interface service 606 may include options within portal summary selection interface 900 to combine all redundant records into a single portlet instance within a summary portal page with timestamps displayed with the portlet instance for each of the redundant records.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

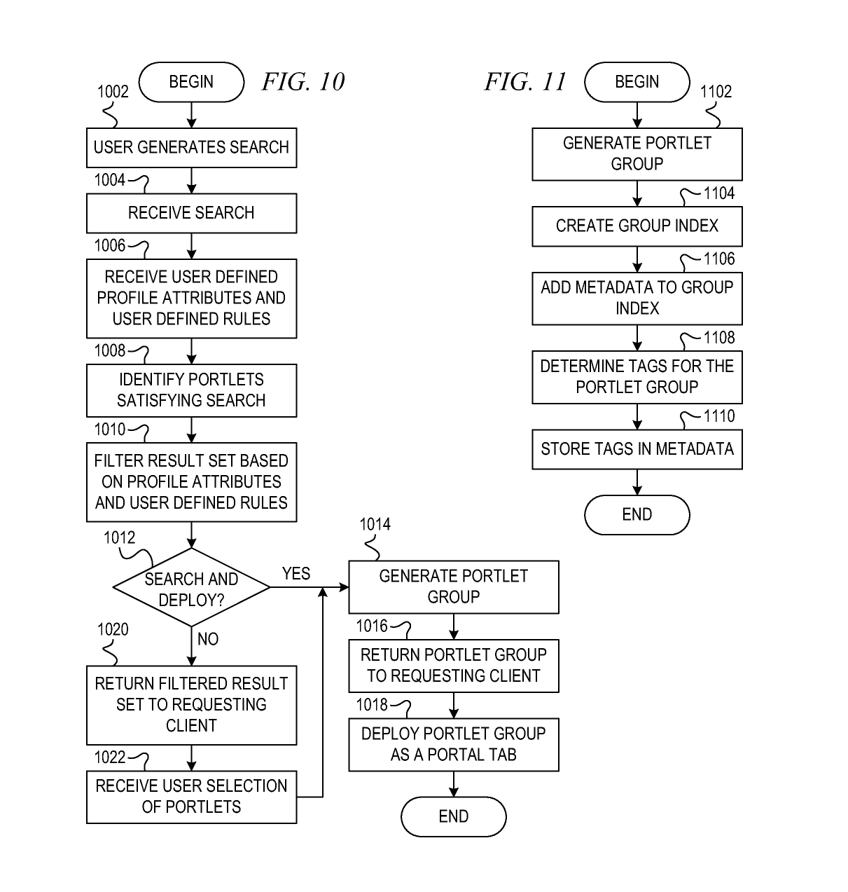

FIG. 10 is a flowchart illustrating operation of a system for applying user generated deployment events to a grouping of bookmarked deployable Web archive files in accordance with an illustrative embodiment. Operation begins, and a user generates a search query (block 1002). The system receives the search query (block 1004) and receives user defined profile attributes and user defined rules (block 1006). The system then identifies portlets, or portlet groups, satisfying the search (block 1008). The system then filters the result set based on the profile attributes and user defined rules (block 1010). Thereafter, the system determines whether a “search and deploy” option is indicated in the search query (block 1012).

In an alternative embodiment, the search may be a request for recommendations from a recommendation engine. The system may receive the request for recommendations at block 1004 and generate a result set based on the profile attributes and user defined rules in blocks 1008 and 1010.

If a search and deploy option is indicated in the search query, the system generates a portlet group (block 1014) containing the portlets, or portlet groups, identified in block 1010. The system then returns the portlet group(s) to the requesting client (block 1016) and deploys the portlet group as a portal tab, or tabs, in a portal of the requesting user (block 1018). Thereafter, operation ends.

If a search and deploy option is not indicated in the search query in block 1012, the system returns the filtered result set from block 1010 to the requesting client (block 1020). The system then receives user selection of portlets, or portlet groups, to be included in a portlet group (block 1022). Thereafter, operation proceeds to block 1014 to generate the portlet group(s). Then, the system returns the portlet group, or portlet groups, to the requesting client (block 1016) and deploys the portlet group as a portal tab, or tabs, in a portal of the requesting user (block 1018). Thereafter, operation ends.

FIG. 11 is a flowchart illustrating operation of a system for generating a portlet group for subsequent search, retrieval, and deployment as a portal tab in accordance with an illustrative embodiment. Operation begins, and the system generates a portlet group (block 1102). This portlet group may include portlets individually selected by a user or resulting from a search as described above with respect to FIG. 10. The system then creates a group index (block 1104). The system adds metadata in association with the group index (block 1106). Then, the system determines tags for the portlet group (block 1108). These tags may include tags assigned by the user or tags inherited from the individual portlets, for example. The system then stores the tags in the metadata associated with the portlet group (block 1110). Thereafter, operation ends.

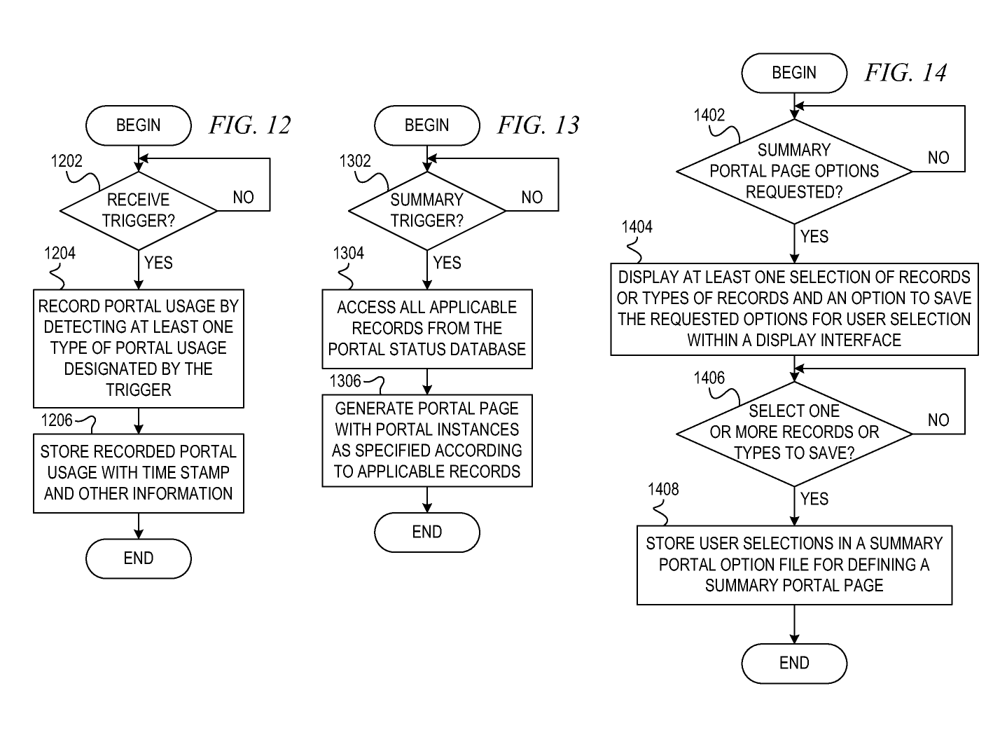

FIG. 12 is a flowchart illustrating operation of a portal summary service recording portal usage in accordance with an illustrative embodiment. Operation begins, and the portal summary service determines whether a trigger to record portal usage is received (block 1202). The trigger may occur based on a user selection, a specified condition being met within portal summary preferences 610, or other events. If the portal summary service does not receive a trigger to record portal usage, then operation returns to block 1202 to determine whether a trigger is received.

If the portal summary service receives a trigger in block 1202, the portal summary service records portal usage by detecting at least one type of portal usage designated for recording by the trigger (block 1204). For example, the trigger may specify recording a particular portlet instance, a particular type of portlet, portlets recorded when a particular user context or state tag was selected, or all portlets. In addition, the trigger may specify recording content, data option selections, or other criteria specifying what to record. Next, the portal summary service stores the recorded portal usage in a record within the portal status database with time stamp and other information (block 1206), and operation ends.

FIG. 13 is a flowchart illustrating operation of a portal summary service generating a summary portal page in accordance with an illustrative embodiment. Operation begins, and the portal summary service determines whether a trigger to generate a summary portal page is detected (block 1302). If the portal summary service does not detect a trigger to generate a summary portal page, then operation returns to block 1302 to determine whether a trigger is detected.

If the portal summary service detects a trigger at block 1302, then the portal summary service accesses all applicable records for the summary portal page from the portal status database (block 1304). In determining applicable records, the portal summary controller may prompt the user to select from record options, may receive previously selected records, may detect record selections or user-defined rules for selecting records from the portal summary preferences, or may detect applicable records from other events or sources. Next, the portal summary service generates a summary portal page with portal instances as specified according to the applicable records (block 1306), and operation ends.

FIG. 14 is a flowchart illustrating operation of a portal summary service specifying a summary portal page in accordance with an illustrative embodiment. Operation begins, and the portal summary service determines whether an option to specify a summary portal page is triggered or requested (block 1402). If the portal summary service does not detect a trigger to specify a summary portal page, then operation returns to block 1402 to determine whether a trigger is detected.

If the portal summary service determines that an option to specify a summary portal page is triggered or requested in block 1402, then the portal summary service displays at least one selection of records or types of records from the portal status database and an option to save the requested options, for user selection within a display interface (block 1404). In addition, as previously described with reference to FIG. 9, the display may also include additional filtering options and may include options to automatically trigger summary portal page generation based on selected options.

Next, the portal summary service determines whether the user has completed the summary portal page specification by selecting to save the selected records or types of records and other selected options (block 1406). If the user has not completed the summary portal page specifications, then operation returns to block 1406 to determine whether the user has completed the summary portal page specification. If the user selects to save the selected options in block 1406, then the portal summary service stores the user selections in a summary portal option file for defining a summary portal page (block 1408), and operation ends.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for providing a user a higher degree of control over personalization of portal content. Users may specify their own profile attributes and rules. The Web portal application may base recommendations for a user based on user-defined context and portal or portlet tags. Furthermore, a portal summary service may allow greater specification of what data is included in a session summary.

The mechanisms of the illustrative embodiments provide new tag types and management of these tags to be used in association with a portal application. Applications of the new tag types comprise filtering of new content in the form of recommendations or search results and filtering of accessed content in the form of session summaries, for example.

The mechanisms provide enhancements to Web portal application software and related database software. Users may specify user context or state via one or more profile tags or enhanced profile attributes. Users may store portlet page tags locally, or associate private tags with the user profile. Users may generate new rules for displayed portlets or portlet recommendation lists. User defined rules may be based on existing available rule-building capabilities and user-defined context tags or enhanced profile attributes and private or public portlet or portal page tags. A portal summary service may apply user-defined rules to both “live” and saved/cached portlet/portal content. The portal summary service may configure generation of portal session summary data according to user-defined context, portlet or portal tags, and rules.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for generating portal content based on user-defined tags and rules, the method comprising:
receiving, from a requesting user, a user-defined profile tag and a user-defined rule;
identifying one or more portlets, from a set of stored portlets, to be presented to the requesting user;
applying the user-defined rule to the one or more portlets based on the user-defined profile tag to filter the one or more portlets to form a filtered set of portlets; and
returning the filtered set of portlets to the user.

2. The method of claim 1, wherein identifying one or more portlets from a set of portlets comprises:
generating a recommendation set of portlets for the requesting user.

3. The method of claim 1, wherein identifying one or more portlets from a set of portlets comprises:
receiving, from the requesting user, search criteria to be applied to the set of stored portlets; and
identifying the one or more portlets, from the set of stored portlets, satisfying the search criteria.

4. The method of claim 3, wherein identifying the one or more portlets from the set of stored portlets satisfying the search criteria comprises:
identifying one or more portlet groups that satisfy the search query.

5. The method of claim 1, wherein identifying one or more portlets from a set of portlets comprises:
storing detected usage of at least one instance of the one or more portlets within at least one portal page separately at each of a plurality of different times; and
dynamically creating a summary portal page displaying a separate instance of the one or more portlets for at least one of each of the plurality of different times specified according to the detected usage separately stored at each of the plurality of different times, such that the summary portal page provides a summary of at least a selection of a previous usage of the at least one portal page.

6. The method of claim 1, wherein the user-defined profile tag defines a user state or context at a given time.

7. The method of claim 1, wherein the user-defined profile tag is enabled or disabled from a set of user-defined profile tags.

8. The method of claim 1, wherein the user-defined profile tag comprises a user state or context assigned by the user to a given portlet from the set of stored portlets.

9. The method of claim 1, further comprising:
deploying the filtered set of portlets in one or more portal tabs within a Web portal of the requesting user.

10. A computer program product comprising a computer recordable medium having a computer readable program recorded thereon, wherein the computer readable program, when executed on a computing device, causes the computing device to:
receive, from a requesting user, a user-defined profile tag and a user-defined rule;
identify one or more portlets, from a set of stored portlets, to be presented to the requesting user;
apply the user-defined rule to the one or more portlets based on the user-defined profile tag to filter the one or more portlets to form a filtered set of portlets; and
return the filtered set of portlets to the user.

11. The computer program product of claim 10, wherein identifying one or more portlets from a set of portlets comprises:
generating a recommendation set of portlets for the requesting user.

12. The computer program product of claim 10, wherein identifying one or more portlets from a set of portlets comprises:
receiving, from the requesting user, search criteria to be applied to the set of stored portlets; and
identifying the one or more portlets, from the set of stored portlets, satisfying the search criteria.

13. The computer program product of claim 10, wherein identifying one or more portlets from a set of portlets comprises:
storing detected usage of at least one instance of the one or more portlets within at least one portal page separately at each of a plurality of different times; and
dynamically creating a summary portal page displaying a separate instance of the one or more portlets for at least one of each of the plurality of different times specified according to the detected usage separately stored at each of the plurality of different times, such that the summary portal page provides a summary of at least a selection of a previous usage of the at least one portal page.

14. The computer program product of claim 10, wherein the user-defined profile tag defines a user state or context at a given time.

15. The computer program product of claim 10, wherein the computer readable program is stored in a computer readable storage medium in a data processing system and wherein the computer readable program was downloaded over a network from a remote data processing system.

16. The computer program product of claim 10, wherein the computer readable program is stored in a computer readable storage medium in a server data processing system and wherein the computer readable program is downloaded over a network to a remote data processing system for use in a computer readable storage medium with the remote system.

17. An apparatus, comprising:
a processor; and
a memory coupled to the processor, wherein the memory comprises instructions which, when executed by the processor, cause the processor to:
receive, from a requesting user, a user-defined profile tag and a user-defined rule;
identify one or more portlets, from a set of stored portlets, to be presented to the requesting user;
apply the user-defined rule to the one or more portlets based on the user-defined profile tag to filter the one or more portlets to form a filtered set of portlets; and
return the filtered set of portlets to the user.

18. The apparatus of claim 17, wherein identifying one or more portlets from a set of portlets comprises:
receiving, from the requesting user, search criteria to be applied to the set of stored portlets; and
identifying the one or more portlets, from the set of stored portlets, satisfying the search criteria.

19. The apparatus of claim 17, wherein identifying one or more portlets from a set of portlets comprises:
storing detected usage of at least one instance of the one or more portlets within at least one portal page separately at each of a plurality of different times; and
dynamically creating a summary portal page displaying a separate instance of the one or more portlets for at least one of each of the plurality of different times specified according to the detected usage separately stored at each of the plurality of different times, such that the summary portal page provides a summary of at least a selection of a previous usage of the at least one portal page.

20. The apparatus of claim 17, wherein the user-defined profile tag defines a user state or context at a given time.
